(19) United States
(12) Patent Application Publication
(10) Pub. No.: US 2025/0315878 A1
(43) Pub. Date: Oct. 9, 2025

(54) METHOD AND SYSTEM FOR PRODUCT RECOMMENDATION BASED ON EXAMPLE PRODUCTS AND TEXT INPUT

(71) Applicant: LG MANAGEMENT DEVELOPMENT INSTITUTE CO., LTD., Seoul (KR)

(72) Inventors: Hyemin JUNG, Seoul (KR); Woohyung LIM, Seoul (KR)

(21) Appl. No.: 19/171,326

(22) Filed: Apr. 6, 2025

(30) Foreign Application Priority Data
Apr. 8, 2024 (KR) 10-2024-0047357

(51) Int. Cl. G06Q 30/0601; G06F 40/30

(52) U.S. Cl. CPC G06Q 30/0631; G06F 40/30; G06Q 30/0625

(57) ABSTRACT

Provided are an example product and text input-based product recommendation method and system, which are configured to provide a recommendation product that matches a current intention of a user based on an example product and needs-related text entered by the user.

### CROSS-REFERENCE TO RELATED APPLICATION

This application claims priority from and the benefit of Korean Patent Application No. 10-2024-0047357, filed on Apr. 8, 2024, which is hereby incorporated by reference for all purposes as if fully set forth herein.

### BACKGROUND

### Field

Embodiments of the invention relate generally to a method and system for product recommendation based on example products and text input, and more particularly, to a method and system for product recommendation, which can identify a user's current intention based on example products and text input to provide a recommendation product.

### Discussion of the Background

With the development of untact services, platforms that provide products to consumers online, as well as platforms that provide various products such as music and videos, are actively increasing. As a result, the utilization of the function of providing a recommendation product to a consumer is increasing. In particular, the function of providing a recommendation product based on a user's taste is being actively used in a shopping mall that sells various products such as OTT platforms or music streaming services.

Such a product recommendation system uses various recommendation product selection algorithms to present products that customers want. A product recommendation method may be classified into Collaborative filtering based Recommendation, Sequential/Session based Recommendation, and Contents based Recommendation.

The Collaborative filtering based Recommendation suggests recommendation products to a user by using the product purchase and click information of other users with similar preferences to the user. The Sequential based Recommendation uses a sequential pattern to explore each user's overall preference and suggests a product to the user based on the preference. The Contents based Recommendation suggests items that have similar characteristics to the last item the user clicked or purchased. However, the product that the user wants may change each time. Such a conventional method has a problem that it only recommends a product based on the user's previous tastes, making it difficult to reflect the user's current intention.

The above information disclosed in this Background section is only for understanding of the background of the inventive concepts, and, therefore, it may contain information that does not constitute prior art.

### SUMMARY

Methods and systems for product recommendation based on example products and text input according to embodiments of the invention are capable of providing a recommendation product by inferring a user's current intention.

Further, embodiments of the invention also are capable of performing product recommendation applicable to various product categories.

Additional features of the inventive concepts will be set forth in the description which follows, and in part will be apparent from the description, or may be learned by practice of the inventive concepts.

In an aspect, a computing system including a memory and a processor identifies a user's current intention and provides recommendation product information, and the method includes the steps of inputting a text about at least one example product and a user's current needs, deriving a user's intention vector based on the example product, deriving intention information about the text using a Large Language Model (LLM), deriving an average intention vector based on the intention vector and the intention information, deriving one or more sampling intention vectors based on a probability distribution expressing the user's current intention and the average intention vector, and deriving a product corresponding to the sampling intention vector, and the product comprises a tangible product with value and an intangible product.

The step of deriving the intention vector may include the steps of expressing the example product as an index, sampling k feature vectors from a probability distribution regarding features of the example product, and encoding the feature vector into the intention vector. Here, the k is an integer greater than or equal to 1.

The step of deriving the average intention vector may further include the steps of deriving a density of the intention vector using MPMD (Max Probability position of Mixed Distributions), and deriving the average intention vector based on the density of the intention vector.

The step of deriving the product corresponding to the sampling intention vector may include the steps of deriving an item vector corresponding to the sampling intention vector, converting the item vector into an item index, and displaying a product corresponding to the item index.

The step of deriving the product corresponding to the sampling intention vector may further include the steps of generating user preference information based on a user's past product purchase history, product inquiry history, and search history, and filtering the recommendation item vector based on the item vector and the preference information.

Further, a computing system including a memory and a processor identifies a user's current intention and provides recommendation product information, and the method includes the steps of inputting at least one example product, deriving a user's intention vector based on the example product, deriving an average intention vector based on the intention vector, deriving one or more sampling intention vectors based on a probability distribution expressing the user's current intention and the average intention vector, and deriving a product corresponding to the sampling intention vector, and the product includes a tangible product with value and an intangible product.

Furthermore, a computing system including a memory and a processor identifies a user's current intention and provides recommendation product information, and the method includes the steps of inputting a text about a user's current needs, deriving intention information about the text using a Large Language Model (LLM), deriving an average intention vector based on the intention information, deriving one or more sampling intention vectors based on a probability distribution expressing the user's current intention and the average intention vector, and deriving a product corresponding to the sampling intention vector, and the product includes a tangible product with value and an intangible product.

Furthermore, an example product and text input-based product recommendation system includes at least one memory, and at least one processor reading out at least one application stored in the memory to identify a user's current intention and provide recommendation product information, and the processor acquires a text about at least one example product and a user's current needs, derives a user's intention vector based on the example product, derives intention information about the text using a Large Language Model (LLM), derives an average intention vector based on the intention vector and the intention information, derives one or more sampling intention vectors based on a probability distribution expressing the user's current intention and the average intention vector, and derives a product corresponding to the sampling intention vector, and the product includes a tangible product with value and an intangible product.

Furthermore, a computing device includes at least one memory, and at least one processor reading out at least one application stored in the memory to identify a user's current intention and provide recommendation product information, and commands of the processor include the steps of inputting a text about at least one example product and a user's current needs, deriving a user's intention vector based on the example product, deriving intention information about the text using a Large Language Model (LLM), deriving an average intention vector based on the intention vector and the intention information, deriving one or more sampling intention vectors based on a probability distribution expressing the user's current intention and the average intention vector, and deriving a product corresponding to the sampling intention vector, and the product includes a tangible product with value and an intangible product.

Methods and systems for product recommendation based on example products and text input according to embodiments of the invention can provide a recommendation product by inferring a user's current intention.

Further, Methods and systems for product recommendation based on example products and text input according to embodiments of the invention can perform product recommendation applicable to various product categories.

It is to be understood that both the foregoing general description and the following detailed description are exemplary and explanatory and are intended to provide further explanation of the invention as claimed . . .

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 illustrates a block diagram of a computing system for product recommendation based on example products and text input according to an embodiment of the invention.

FIG. 2 illustrates a block diagram of a computing device for product recommendation based on example products and text input according to an embodiment of the invention.

FIG. 3 illustrates a block diagram of a computing device for product recommendation based on example products and text input according to another embodiment of the invention.

FIG. 4 is a block diagram illustrating a system for product recommendation based on example products and text input according to an embodiment of the invention.

FIG. 5 is an embodiment of a diagram of an intention vector graph.

FIG. 6 is an embodiment of a diagram of an average intention vector derivation graph.

FIG. 7 is a flowchart illustrating a method for product recommendation based on example products according to an embodiment of the invention.

FIG. 8 is a flowchart illustrating a method for product recommendation based on needs text according to another embodiment of the invention.

FIG. 9 is a flowchart illustrating a method for product recommendation based on example products and needs text according to another embodiment of the invention.

FIG. 10 is a flowchart illustrating an embodiment of a first average intention vector derivation method.

FIG. 11 is a flowchart illustrating an embodiment of a recommendation product derivation method.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

When an element, such as a layer, is referred to as being “on,” “connected to,” or “coupled to” another element or layer, it may be directly on, connected to, or coupled to the other element or layer or intervening elements or layers may be present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the invention.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

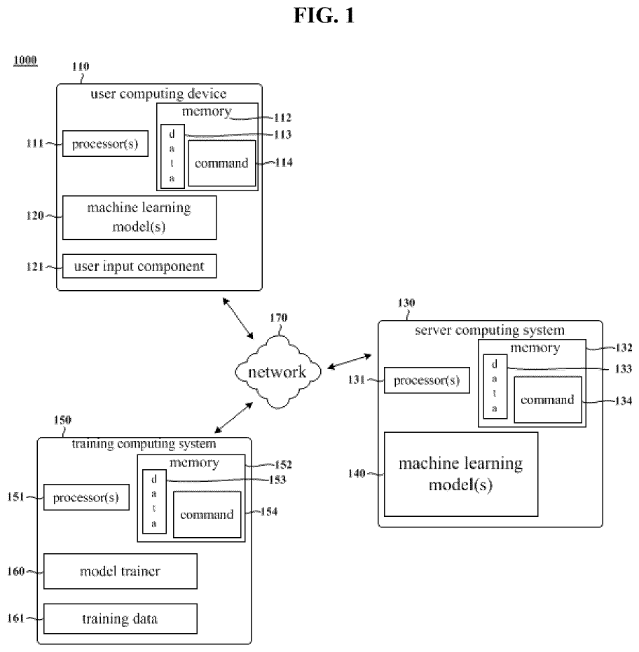

FIG. 1 illustrates a block diagram of a computing system for product recommendation based on example products and text input according to an embodiment of the invention . . .

Referring to FIG. 1, the computing system 1000 for product recommendation based on example products and text input includes a user computing device 110, a server computing system 130, and a training computing system 150, and the devices may communicate with each other via a network 170.

A method for product recommendation based on example products and text input according to an embodiment of the present invention may be locally implemented and provided by the user computing device 110, may be implemented and provided in the form of a web service by the server computing system 130 communicating with the user computing device 110, or may be implemented and provided by the user computing device 110 and the server computing system 130 in conjunction with each other.

In an embodiment, the user computing device 110 and/or the server computing system 130 may train a language model (machine learning model) 120 and/or 140 through interaction with a training computing system 150 that is communicatively connected via the network 170. The training computing system 150 may be separate from the server computing system 130 or may be part of the server computing system 130.

An artificial intelligence model (in the embodiment, language model or the like) may be trained locally and directly by the user computing device 110, may be trained by the server computing system 130 and the user computing device 110 while they interact with each other via the network 170, and may be trained by a separate training computing system 150 using various training techniques and learning techniques. Further, the artificial intelligence model trained by the training computing system 150 may be provided and updated by being transmitted to the user computing device 110 and/or the server computing system 130 via the network 170.

In an embodiment of the present invention, the training computing system 150 may be part of the server computing system 130, or part of the user computing device 110.

The user computing device 110 may include any type of computing device, such as a smart phone, a mobile phone, a digital broadcasting device, a personal digital assistant (PDA), a portable multimedia player (PMP), a desktop, a wearable device, an embedded computing device, and/or a tablet PC.

Such a user computing device 110 includes at least one processor 111 and a memory 112. Here, the processor 111 may be composed of at least one processor or a plurality of electrically connected processors among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions.

The memory 112 may include one or more non-transitory/transitory computer-readable storage media, such as RAM, ROM, EEPROM, EPROM, flash memory devices, magnetic disks, and combinations thereof, and may include web storage of a server performing the storage function of the memory on the Internet. Such a memory 112 may store data 113 and commands 114 necessary for at least one processor 111 to perform functional operations, such as training the artificial intelligence model or executing outlier detection using the artificial intelligence model.

In an embodiment, the user computing device 110 may store at least one machine learning model 120.

The machine learning model 120 may be various machine learning models such as multiple neural networks (e.g., deep neural networks) or other types of machine learning models including nonlinear models and/or linear models, and may be composed of a combination thereof.

The neural network may include at least one of feed-forward neural networks, recurrent neural networks (e.g., long- and short-term memory recurrent neural networks), convolution neural networks, and/or other forms of neural networks.

In an embodiment, the user computing device 110 may receive at least one machine learning model 120 from the server computing system 130 via the network 170, store it in the memory 112, and then execute the stored machine learning model 120 by the processor 111 to perform outlier detection, etc.

In an embodiment, the server computing system 130 may include at least one machine learning model 140 to perform an operation through the machine learning model 140, and provide a user with the language model that performs instruction tuning using a heterogeneous language by linking with the user computing device 110 in a manner that communicates data related thereto with the user computing device 110.

For example, the user computing device 110 may provide the language model that performs instruction tuning in such a way that the server computing system 130 provides output for the user's input using the machine learning model 140 via the web.

The artificial intelligence model may also be implemented in such a way that at least some of the machine learning models 120 and/or 140 are executed on the user computing device 110 and the rest are executed on the server computing system 130.

Further, the user computing device 110 may include at least one input component 121 that detects user input. For example, the user input component 121 may include a touch sensor (e.g., a touch screen and/or a touch pad, etc.) that detects the touch of a user's input medium (e.g., a finger or a stylus), an image sensor that detects the user's motion input, a microphone, button, mouse, and/or keyboard that detects the user's voice input, etc.

Furthermore, the user input component 121 may include an interface and an external controller when receiving input from an external controller (e.g., a mouse and/or keyboard) through the interface.

The server computing system 130 preferably includes at least one processor 131 and a memory 132. Here, the processor 131 may be composed of at least one processor or a plurality of electrically connected processors among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions.

The memory 132 may include one or more non-transitory/transitory computer-readable storage media, such as RAM, ROM, EEPROM, EPROM, flash memory devices, magnetic disks, and combinations thereof. Such a memory 132 may store data 133 and commands 134 necessary for the processor 131 to perform functional operations, such as training the artificial intelligence model or executing outlier detection using the artificial intelligence model.

In an embodiment, the server computing system 130 may be implemented to include at least one computing device. For example, the server computing system 130 may be implemented to operate multiple computing devices according to a sequential computing architecture, a parallel computing architecture, or a combination thereof. Further, the server computing system 130 may include a plurality of computing devices connected via the network 170.

The server computing system 130 may store at least one machine learning model 140. For example, the server computing system 130 may include a neural network and/or other multi-layer non-linear models as the machine learning model 140. Example neural networks may include feed-forward neural networks, deep neural networks, recurrent neural networks, and convolution neural networks.

The training computing system 150 preferably includes at least one processor 151 and a memory 152. Here, the processor 151 may be composed of at least one processor or a plurality of electrically connected processors among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or other electrical units for performing functions.

The memory 152 may include one or more non-transitory/transitory computer-readable storage media, such as RAM, ROM, EEPROM, EPROM, flash memory devices, magnetic disks, and combinations thereof. Such a memory 152 may store data 153 and commands 154 necessary for the processor 151 to perform the learning of the artificial intelligence model.

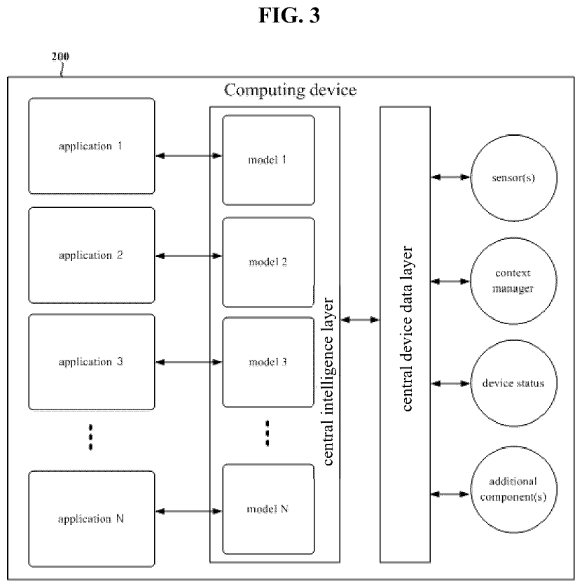

For example, the training computing system 150 may include a model trainer 160 that trains the machine learning model 120 and/or 140 stored in the user computing device 110 and/or server computing system 130, using various training or learning techniques, such as back-propagation of errors (according to a framework illustrated in FIG. 3).

For example, such a model trainer 160 may perform updates to one or more parameters of the machine learning model 120 and/or 140 in a back-propagation manner based on a defined loss function.

In some implementations, performing the back-propagation of errors may involve performing truncated back-propagation through time. The model trainer 160 may perform a number of generalization techniques (e.g., weight reduction, dropout, and/or knowledge distillation) to improve the generalization ability of the trained machine learning model 120 and/or 140.

In particular, the model trainer 160 may train the machine learning model 120 and/or 140 based on a series of training data 161. Here, the training data 161 may include data in different formats, such as images, audio samples, and/or text.

The training data 161 may be provided by the user computing device 110 and/or the server computing system 130. When the training computing device trains the machine learning model 120 and/or 140 on specific data of the user computing device 110, the machine learning model 120 and/or 140 may be characterized as a personalized model.

The model trainer 160 preferably includes computer logic that is utilized to provide a desired function.

Further, the model trainer 160 may be implemented as hardware, firmware and/or software, which controls a general-purpose processor. In one implementation, the model trainer 160 contains a program file stored in a storage device, which may be loaded into the memory 152 and executed by one or more processors 151. In another implementation, the model trainer 160 may include one or more sets of computer-executable data 153 and commands 154 stored on a tangible computer-readable storage medium, such as a RAM hard disk or an optical or magnetic medium.

The network 170 preferably includes, but is not limited to, a 3rd Generation Partnership Project (3GPP) network, a Long Term Evolution (LTE) network, a World Interoperability for Microwave Access (WIMAX) network, the Internet, a Local Area Network (LAN), a Wireless Local Area Network (Wireless LAN), a Wide Area Network (WAN), a Personal Area Network (PAN), a Bluetooth network, a satellite broadcasting network, an analog broadcasting network, and/or a Digital Multimedia Broadcasting (DMB) network.

In general, communication over the network 170 may be performed via various communication protocols (e.g., TCP/IP, HTTP, SMTP, and/or FTP, etc.), encodings or formats (e.g., HTML and/or XML, etc.), and/or protection schemes (e.g., VPN, Secure HTTP, and/or SSL, etc.), using any type of wired and/or wireless connection.

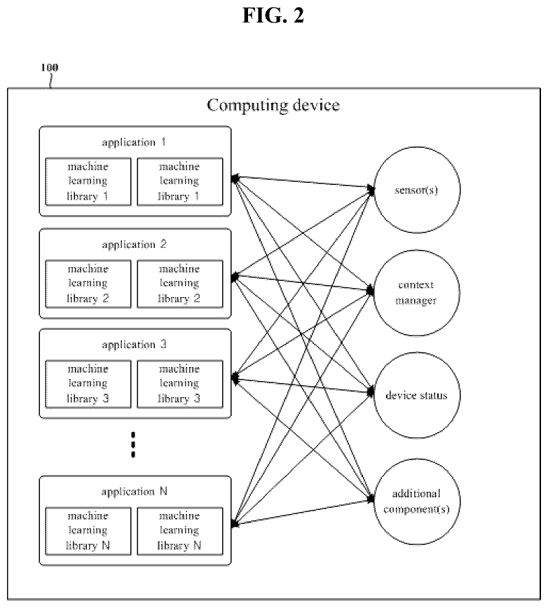

FIG. 2 illustrates a block diagram of a computing device for product recommendation based on example products and text input according to an embodiment of the invention . . .

Referring to FIG. 2, the computing device 100 included in the user computing device 110, the server computing system 130, and the training computing system 150 preferably include a plurality of applications (e.g., application 1 to application N). Each application may include a machine learning library and one or more machine learning models. For example, the application may include a language processing application, a text messaging application, an E-mail application, a dictation application, a virtual keyboard application, a browser application, and/or a Chat-bot application.

In an embodiment, the computing device 100 may include the model trainer 160 for training the artificial intelligence model, and may provide output data according to predetermined input data (e.g., image data, etc.) by storing and operating the trained artificial intelligence model.

Each application of the computing device 100 may communicate with a number of other components of the computing device 100, such as, for example, at least one sensor, a context manager, a device state component, and/or additional components. Each application may communicate with each device component using an API (e.g., a public API). Further, the API used by each application may be specific to the corresponding application.

FIG. 3 illustrates a block diagram of a computing device 100 for product recommendation based on example products and text input according to another embodiment of the invention.

Referring to FIG. 3, the computing device 300 preferably includes a plurality of applications (e.g., application 1 to application N). Each application may include a central intelligence layer. For example, the application may include a language processing application, a text messaging application, an E-mail application, a dictation application, a virtual keyboard application, and/or a browser application. Each application may communicate with the central intelligence layer (and the models stored therein) using the API (e.g. a common API across all applications).

The central intelligence layer may include a plurality of machine learning models. For example, as shown in FIG. 3, at least some of the machine learning models may be provided for each application and managed by the central intelligence layer. In another implementation, two or more applications may share a single machine learning model. For example, in some implementations, the central intelligence layer may provide a single model to all applications. In some implementations, the central intelligence layer may be included within the operating system of the computing device 300 or implemented otherwise.

The central intelligence layer may communicate with a central device data layer. The central device data layer may be a centralized data storage for the computing devices 300. As shown in FIG. 3, the central device data layer may communicate with a number of other components of the computing device 300, such as, for example, one or more sensors, a context manager, a device state component, and/or additional components. In some implementations, the central device data layer may communicate with each device component using an API (e.g., a private API).

The techniques described herein may refer to servers, databases, software applications and other computer-based systems, as well as actions taken and information transmitted to or from such systems. It will be recognized that the intrinsic flexibility of the computer-based systems allows for a wide range of possible configurations, combinations, and divisions of work and functionality between and from components. For example, the processes described herein may be implemented using a single device or component, or multiple devices or components operating in combination. The databases and applications may be implemented on a single system or a system distributed across multiple systems. Distributed components may operate sequentially or in parallel.

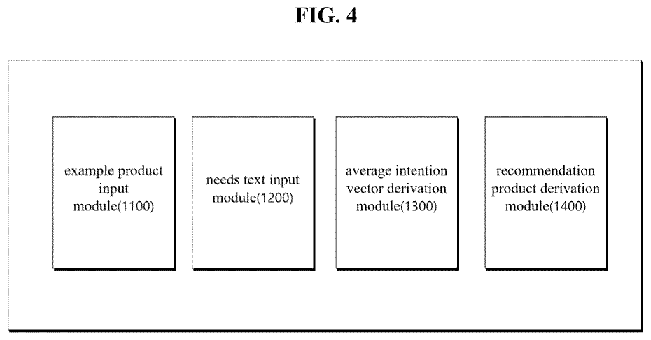

Hereinafter, an example product and text input-based product recommendation system according to an embodiment of the present invention will be described with reference to FIG. 4.

FIG. 4 is a block diagram illustrating a system for product recommendation based on example products and text input according to an embodiment of the invention.

The system 1000 for product recommendation based on example products and text input may mean the artificial intelligence model that recommends a product to a user based on an example product and text selected or entered by the user.

The system 1000 for product recommendation based on example products and text input 1000 preferably includes the memory and the processor. At least one application is stored in the memory, and the processor reads the application stored in the memory and performs data processing to provide a recommended product.

The functions of the system 1000 for product recommendation based on example products and text input 1000 for providing the recommended product may be illustrated using the block diagram as shown in FIG. 4. Referring to FIG. 4, the processor may perform the functions of an example product input module 1100, a needs text input module 1200, an average intention vector derivation module 1300, and a recommendation product derivation module 1400, which will be described below.

The example product input module 1100 provides an example product input interface to a user terminal and receives example product information selected by the user. At this time, the user may select N or more items as the example product, where N can mean a natural number greater than or equal to 2.

The example product input module 1100 may receive example product information by using a method in which a user inputs a product name or a product keyword. The example product input module 1100 may create an interface including an example product information input window for receiving information about the example product from the user and provide it to the user terminal. The example product information input window may be used to search for and select a product, or to enter the product name and related keywords.

The needs text input module 1200 provides a needs text input interface to the user terminal, and allows the user to receive text information about a product he or she currently wants or his or her current need. The needs text input module 1200 may receive text related to the user's needs in the form of words or sentences.

The average intention vector derivation module 1300 performs data processing and learning based on example product information and needs text information received from the user to derive an intention vector expressing a reason why the product is selected by the user. To this end, the average intention vector derivation module 1300 may separately perform the intention vector conversion processing step for the example product and the intention vector conversion processing step for the needs text.

To derive the intention vector for the example product, the average intention vector derivation module 1300 preferably generates sessions for N example products, product names, and keywords. The session created at this time may be expressed as shown in Equation 1 below.

$$Session = [ word 1 , word 2 , … , word n ] \qquad [ Equation 1 ]$$

In Equation 1 described above, words 1 to N are words corresponding to N example products, product names, and keywords. The product names and keywords are entered identically. When example product information is entered, text regarding the product name and product type may be derived from the product information and used.

The average intention vector derivation module 1300 preferably converts the word included in the derived session into an index using Equation 1 described above. The item expressed as the index may be expressed as in Equation 2 below.

$$Session = [ 1 , 2 , … , n ] \qquad [ Equation 2 ]$$

In Equation 2 described above, 1 corresponds to word 1, 2 corresponds to word 2, and n corresponds to word n.

The average intention vector derivation module 1300 may perform index transformation using libraries such as NLTK (Natural Language Toolkit), TensorFlow, and PyTorch.

Further, the average intention vector derivation module 1300 samples k feature data from a probability distribution expressing the features of each product based on the session S.

The probability distribution representing product-specific features may be generated based on information about the products. For example, features such as product size, color, price, and material are set, and it is determined whether each feature is a continuous or discrete variable. In the case of the continuous variable, a probability density function may be used to represent the distribution of features. In the case of the discrete variable, a probability mass function may be used to generate the probability distribution that expresses the features of each product.

The k feature data sampled from the probability distribution expressing the features of each product may be expressed as in Equation 3 below.

$$Data S = [ {{X}_{1}}^{1} , {{X}_{1}}^{2} , ... , {{X}_{1}}^{k} , \\ {{X}_{2}}^{1} , {{X}_{2}}^{2} , ... , {{X}_{2}}^{k} , {{X}_{n}}^{1} , {{X}_{n}}^{2} , ... , {{X}_{n}}^{k} ] \qquad [ Equation 3 ]$$

In Equation 3 described above, n represents the number of input products, and k represents the number of data sampled for each product. Therefore, X: means jth data of an i-item. Further, a total number of data sampled using Equation 3 described above is N*K.

The average intention vector derivation module 1300 inputs a plurality of sampled feature data into an encoder using Equation 3 to derive the intention vector. At this time, the average intention vector derivation module 1300 may use an Autoencoder or a Recurrent Neural Network Encoder. The intention vector derived using the encoder can be expressed in the form of Equation 4 below.

$$Vector S = [ {{Z}_{1}}^{1} , {{Z}_{1}}^{2} , ... , {{Z}_{1}}^{k} , \\ {{Z}_{2}}^{1} , {{Z}_{2}}^{2} , ... , {{Z}_{2}}^{k} , {{Z}_{n}}^{1} , {{Z}_{n}}^{2} , ... , {{Z}_{n}}^{k} ] \qquad [ Equation 4 ]$$

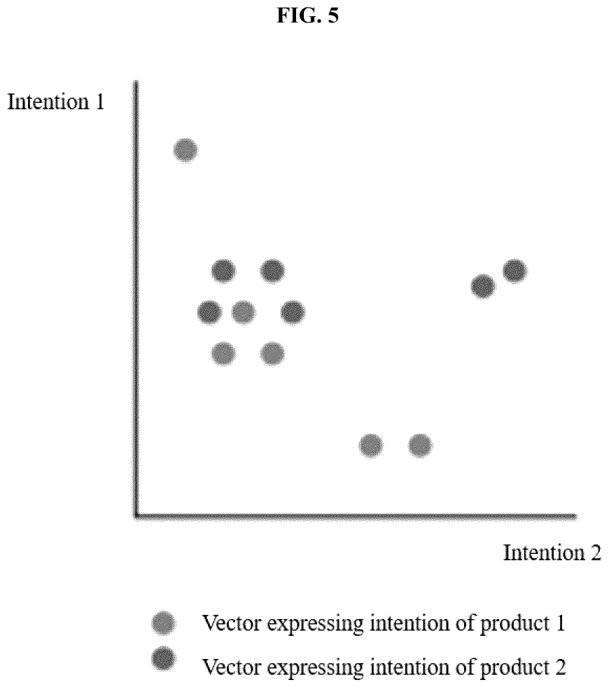

In Equation 4 described above, Zᵢ^{j} means the jth intention vector of the i-item converted in response to the jth data of the i-item, and may be expressed as in the graph of FIG. 5, when the intention vector included in Vector S derived according to Equation 4 is visually displayed.

FIG. 5 is an embodiment of a diagram of an intention vector graph. Referring to FIG. 5, the Y-axis may represent the degree of intention 1, the X-axis may represent the degree of intention 2, and one or more intention vectors corresponding to product 1 and one or more intention vectors corresponding to product 2 may be displayed on the graph.

Further, the average intention vector derivation module 1300 derives a first average intention vector Uₛ₁ based on the intention vector using MPMD (Max Probability position of Mixed Distributions).

MPMD is a process of finding the most overlapping reasons for all products in the session when various reasons for selecting each product are given. This can derive the intention of the session, i.e. the user's current intention. Therefore, MPMD may correspond to a process and method that searches for the most overlapping part using a distance between respective intention vectors.

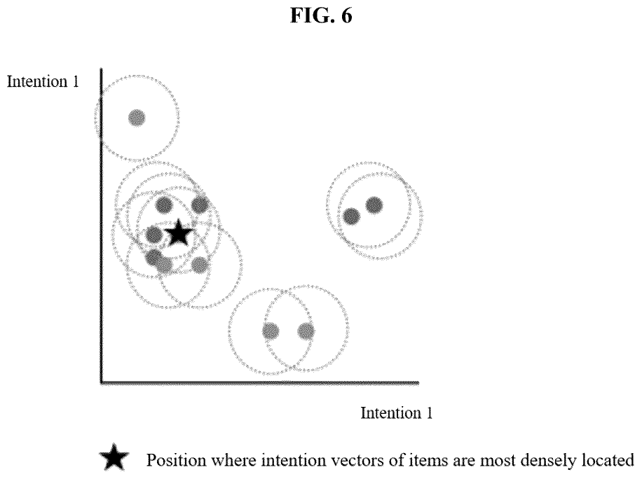

The process of deriving the average intention vector using MPMD may be expressed visually as in the graph in FIG. 6. FIG. 6 is an embodiment of a diagram of an average intention vector derivation graph.

Referring to FIG. 6, the Y-axis may represent the degree of intention 1, and the X-axis may represent the degree of intention 2. Using the distance between the intention vector of product 1 and the intention vector of product 2, a position with the highest density may be derived as an average position vector.

To derive the average intention vector for the needs text, the average intention vector derivation module 1300 inputs the needs text into a large language model (LLM) to identify the user's intention and derives a second average intention vector U_{S2}.

To be more specific, the average intention vector derivation module 1300 maps words corresponding to the needs text to high-dimensional real-valued vectors using embedding techniques such as Word2Vec, GloVe, and FastText.

The average intention vector derivation module 1300 preferably derives the average intention vector by deriving the average of the vectors of respective embedded words to derive a second average intention vector for the needs text. The method by which the average intention vector derivation module 1300 derives the second average intention vector from each embedded word vector may be expressed as shown in the following Equation 5.

$${U}_{S 2} = \frac{1}{m} {\sum }_{i = 1}^{m} {V}_{t}^{i} \qquad [ Equation 5 ]$$

In Equation 5 described above, m represents the number of words entered in the needs text, Vₜ represents an embedded vector, and Vₜⁱ represents an embedded vector corresponding to the i-th word.

Therefore, the average intention vector derivation module 1300 derives a second average intention vector U_{S2} for the needs text input by the user using the large language model and Equation 5 described above.

The recommendation product derivation module 1400 derives a sampling intention vector for the user's current intention based on the first average intention vector U_{S2} and the second average intention vector U_{S2}, and derives a recommendation product that matches the user's current needs based on the derived sampling intention vector.

To be more specific, the recommendation product derivation module 1400 preferably derives a sampling intention vector regarding the user's current intention from the probability distribution representing the user's current intention based on each of the first average intention vector U_{S1} and the second average intention vector U_{S2}. The probability distribution representing the user's current intention may be generated by collecting and analyzing the user's input data and its corresponding intention (label).

The recommendation product derivation module 1400 collects the user's intention (label) from history data about the user's past purchases, searches, and clicked products. Further, a machine learning model such as logistic regression, decision trees, random forests, and neural networks may be used to generate the probability distribution about the user's intention.

The method of deriving the sampling intention vector can be expressed as Equation 6 below.

$$Sample vector = [ {{Z}_{S}}^{1} , {{Z}_{S}}^{2} , ... , {{Z}_{S}}^{j} ] \qquad [ Equation 6 ]$$

In Equation 6, Z_{S}¹ represents a first sampling intention vector, Zₛ² represents a second sampling intention vector, and Zₛⁱ represents a jth sampling intention vector.

Further, the recommendation product derivation module 1400 preferably generates a product associated with the sampling intention vector based on the sampling intention vector. The method of deriving an associated product vector from the sampling intention vector may be expressed as in Equation 7.

$$Sample Item = [ {{X}_{S}}^{1} , {{X}_{S}}^{2} , ... , {{X}_{S}}^{j} ] \qquad [ Equation 7 ]$$

In Equation 7, Xₓ¹ represents an associated product vector corresponding to Zₛ¹, Xₛ² represents an associated product vector corresponding to Zₛ², and Xₛⁱ represents an associated product vector corresponding to Zₛ^{j}.

The recommendation product derivation module 1400 may perform filtering on the associated product derived from the first average intention vector and the associated product vector derived from the second average intention vector to select a final recommendation product and provide it to the user.

The recommendation product derivation module 1400 may infer overall preference information based on the user's past history in the process of filtering the associated product, and perform sampling of the associated product based on the inferred user preference information.

The user's past history data may include the user's past product purchase history, product inquiry history, and search history.

The recommendation product derivation module 1400 may convert the filtered associated product vector into a product index and convert the product index into a product name to provide recommended product information to the user. Therefore, the recommendation product derivation module 1400 may provide one or more recommended product names or provide information on products searched for by recommended product names to the user terminal.

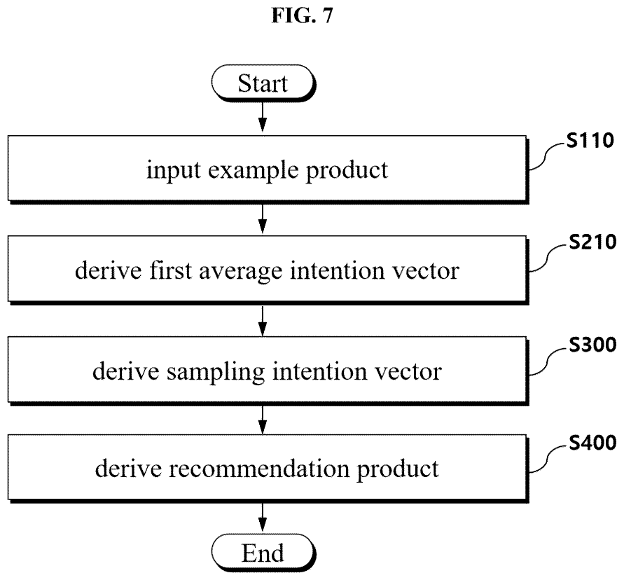

Hereinafter, a method for product recommendation based on example products according to an embodiment of the present invention will be described in detail with reference to FIG. 7.

FIG. 7 is a flowchart illustrating a method for product recommendation based on example products according to an embodiment of the invention.

Referring to FIG. 7, the method for product recommendation based on example products preferably includes an example product input step S110, a first average intention vector derivation step S210, a sampling intention vector derivation step S300, and a recommendation product derivation step S400.

In the example product input step S110, the example product and text input-based product recommendation system 1000 preferably provides an example product input interface to the user terminal and receives example product information selected by the user. At this time, the user may select N or more items as the example product, and N may mean a natural number greater than or equal to 2.

Further, in the example product input step S110, the example product and text input-based product recommendation system 1000 may receive example product information by using a method of inputting the product name or the product keyword.

For example, the example product and text input-based product recommendation system 1000 may generate the interface including the example product information input window for receiving information about the example product from the user and provide it to the user terminal. The user may enter example product information by searching for and selecting the product in the example product information input window or by entering the product name and related keywords.

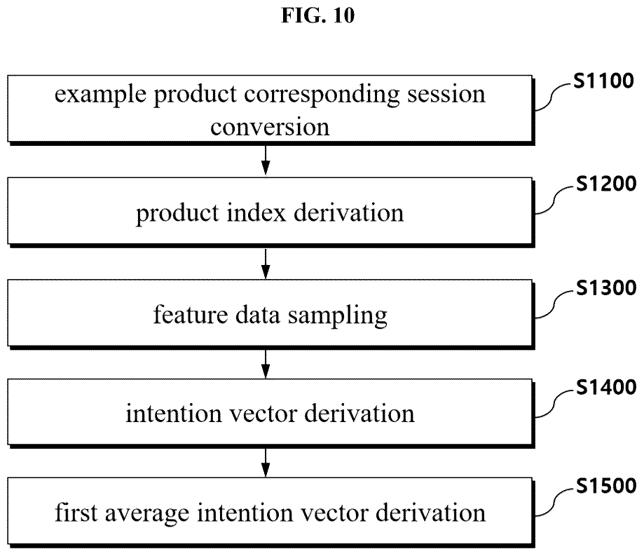

In the first average intention vector derivation step S210, the example product and text input-based product recommendation system 1000 derives one or more intention vectors for the example product and derives the first average intention vector Uₛ₁ having a high density of intention vectors. A detailed method of deriving the first average intention vector Uₛ₁ is described in detail with reference to FIG. 10 described below.

In the sampling intention vector derivation step S300, the example product and text input-based product recommendation system 1000 derives one or more sampling intention vectors regarding the user's current intention from a probability distribution representing the user's current intention based on the first average intention vector Us₁.

The example product and text input-based product recommendation system 1000 may collect and analyze user input data and its corresponding intention (label) to generate the probability distribution expressing the current intention.

For example, the example product and text input-based product recommendation system 1000 collects the user's intention (label) from history data about the user's past purchases, searches, and clicked products. Further, the machine learning model such as logistic regression, decision trees, random forests, and neural networks may be used to generate the probability distribution about the user's intention.

In the sampling intention vector derivation step S300, the example product and text input-based product recommendation system 1000 derives one or more sampling intention vectors regarding the user's current intention from the probability distribution representing the user's current intention based on the first average intention vector Uₛ₁.

In the recommendation product derivation step S400, the example product and text input-based product recommendation system 1000 infers the user's overall preference information based on the user's past history. The example product and text input-based product recommendation system 1000 filters one or more sampling intention vectors based on inferred user preference information to derive a recommendation product suitable for the user's current intention.

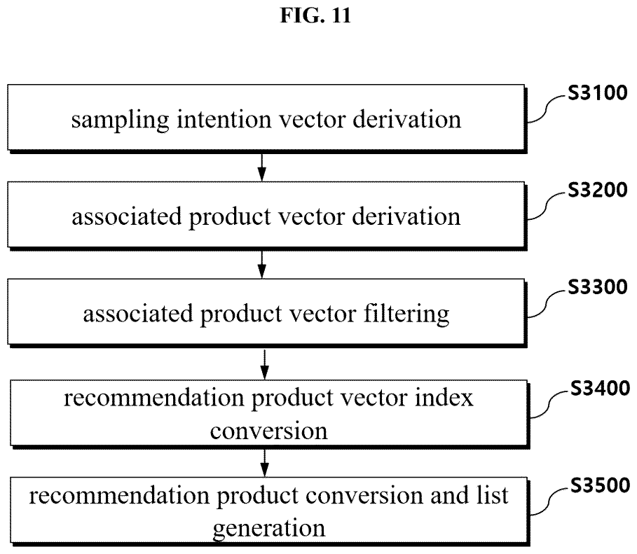

A detailed process of deriving the recommendation product will be described in detail with reference to FIG. 11 below.

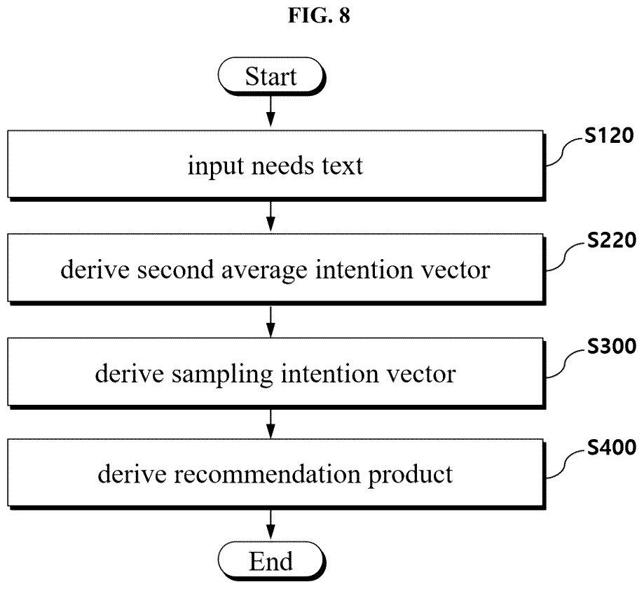

Hereinafter a method for product recommendation based on needs text according to an embodiment of the present invention will be described in detail with reference to FIG. 8.

FIG. 8 is a flowchart illustrating a method for product recommendation based on needs text according to another embodiment of the invention.

Referring to FIG. 8, the method for product recommendation based on needs text preferably includes a needs text input step S120, a second average intention vector derivation step S220, a sampling intention vector derivation step S300, and a recommendation product derivation step S400.

In the needs text input step S120, the example product and text input-based product recommendation system 1000 provides the needs text input interface to the user terminal, and receives text information about a product a user currently wants or current needs.

In the needs text input step S120, the user inputs a needs text related to the user's needs in the form of words or sentences using the terminal. The example product and text input-based product recommendation system 1000 may receive the needs text input by the user into the terminal.

In the second average intention vector derivation step S220, the example product and text input-based product recommendation system 1000 identifies an intention about the text and derives the second average intention vector Us₂.

In the second average intention vector derivation step S220, the example product and text input-based product recommendation system 1000 inputs the needs text into the large language model (LLM) to identify the user's intention and derives the second average intention vector Usz based on the identified intention.

To be more specific, in the second average intention vector derivation step S220, the example product and text input-based product recommendation system 1000 maps words corresponding to the needs text to high-dimensional real-valued vectors using embedding techniques such as Word2Vec, GloVe, and FastText.

In the second average intention vector derivation step S220, the example product and text input-based product recommendation system 1000 derives the average intention vector by deriving the average of the vectors of respective embedded words to derive the second average intention vector for the needs text. Then, using Equation 5 described above, the second average intention vector Usz is derived from each embedded word vector.

In the sampling intention vector derivation step S300, the example product and text input-based product recommendation system 1000 derives one or more sampling intention vectors regarding the user's current intention from the probability distribution representing the user's current intention based on the second average intention vector Usz in the same manner as described above.

In the recommendation product derivation step S400, the example product and text input-based product recommendation system 1000 infers the user's overall preference information based on the user's past history as described above. Further, the example product and text input-based product recommendation system 1000 filters one or more sampling intention vectors based on inferred user preference information to derive the recommendation product suitable for the user's current intention.

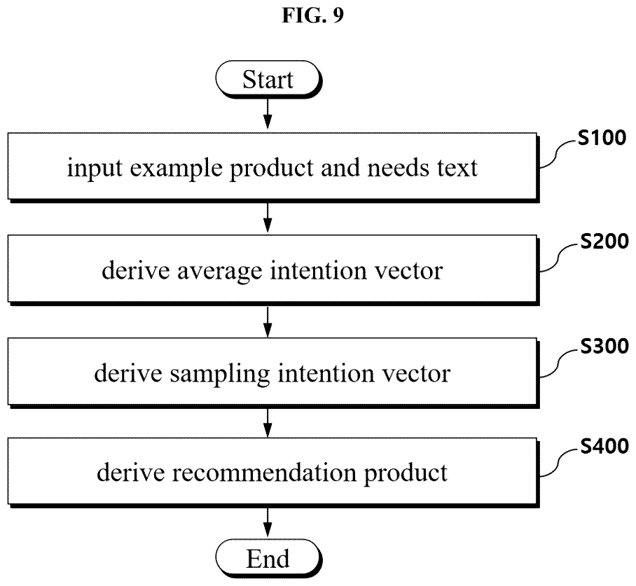

Hereinafter, a method for product recommendation based on example products and needs text according to another embodiment will be described in detail with reference to FIG. 9.

FIG. 9 is a flowchart illustrating a method for product recommendation based on example products and needs text according to another embodiment of the invention.

Referring to FIG. 9, the method for product recommendation based on example products and needs text according to an embodiment of the present invention preferably includes an example product and needs text input step S100, an average intention vector derivation step S200, a sampling intention vector derivation step S300, and a recommendation product derivation step S400.

The example product and needs text-based product recommendation method according to an embodiment of the present invention is preferably applied by combining the above-described example product-based product recommendation method and needs text-based product recommendation method.

Therefore, a first average intention vector Uₛ₁ for the example product and a second average intention vector Uₛ₂ for the needs text are derived, and sampling and filtering are performed on the first average intention vector Uₛ₁ and the second average intention vector Uₛ₂ to derive a recommendation product.

In the example product and needs text input step S100, the example product and text input-based product recommendation system 1000 performs the above-described example product input step S110 and needs text input step S120.

Therefore, the example product and text input-based product recommendation system 1000 provides the example product input interface to the user terminal and receives example product information selected by the user. In addition, the example product and text input-based product recommendation system 1000 provides the needs text input interface to the user terminal, and receives text information about a product the user currently wants or current needs.

In the average intention vector derivation step S200, the example product and text input-based product recommendation system 1000 performs the above-described first average intention vector derivation step S210 and second average intention vector derivation step S220.

Therefore, one or more intention vectors are derived from the example product to derive the first average intention vector Uₛ₁, and an intention analysis is performed on the needs text using the large language model to derive the second average intention vector Uₛ₂ on the needs text.

In the sampling intention vector derivation step S300, the example product and text input-based product recommendation system 1000 derives one or more sampling intention vectors regarding the user's current intention from the probability distribution representing the user's current intention based on the first average intention vector Uₛ₁ and the second average intention vector Uₛ₂.

In the recommendation product derivation step S400, the example product and text input-based product recommendation system 1000 infers the user's overall preference information based on the user's past history. The example product and text input-based product recommendation system 1000 filters one or more sampling intention vectors based on inferred user preference information to derive a recommendation product suitable for the user's current intention.

Thus, the example product and text input-based product recommendation system 1000 may analyze the user's current intention based on example products and need texts entered by the user and recommend products suitable for the user's current intention.

Hereinafter, a first average intention vector derivation method according to an embodiment of the present invention will be described in detail with reference to FIG. 10.

FIG. 10 is a flowchart illustrating an embodiment of a first average intention vector derivation method.

Referring to FIG. 10, the first average intention vector derivation method according to an embodiment of the present invention preferably includes an example product corresponding session conversion step S1100, a product index derivation step S1200, a feature data sampling step S1300, an intention vector derivation step S1400, and a first average intention vector derivation step S1500.

In the example product corresponding session conversion step S1100, the example product and text input-based product recommendation system 1000 creates sessions for N example products, product names, and keywords. At this time, the example product and text input-based product recommendation system 1000 creates a session for N input products using Equation 1 described above.

As described above, words 1 to N included in the session are words corresponding to N example products, product names, and keywords. The product names and keywords are entered identically. When example product information is input, text regarding the product name and product type may be derived from the product information and used.

In the product index derivation step S1200, the example product and text input-based product recommendation system 1000 converts words included in the derived session into an index. At this time, the example product and text input-based product recommendation system 1000 may derive the session S by performing index conversion of words 1 to N from 1 to n using Equation 2 described above.

In the feature data sampling step S1300, the example product and text input-based product recommendation system 1000 samples k feature data from the probability distribution expressing the features of each product based on the session S.

At this time, the example product and text input-based product recommendation system 1000 may generate the probability distribution representing product-specific features based on information about the products. For example, features such as product size, color, price, and material are set, and it is determined whether each feature is a continuous or discrete variable. In the case of the continuous variable, a probability density function may be used to represent the distribution of features. In the case of the discrete variable, a probability mass function may be used to generate the probability distribution that expresses the features of each product.

Further, in the feature data sampling step S1300, the example product and text input-based product recommendation system 1000 derives Data S by sampling k feature data from the probability distribution expressing product-specific features using Equation 3 described above.

In the intention vector derivation step S1400, the example product and text input-based product recommendation system 1000 inputs a plurality of sampled feature data into the encoder using Equation 3 to derive the intention vector. At this time, the example product and text input-based product recommendation system 1000 may use the Autoencoder or the Recurrent Neural Network Encoder. The intention vector derived using the encoder can be expressed in the form of Equation 4 described above.

In the first average intention vector derivation step S1500, the example product and text input-based product recommendation system 1000 derives the first average intention vector Uₛ₁ based on the intention vector using MPMD (Max Probability position of Mixed Distributions).

In the first average intention vector derivation step S1500, the example product and text input-based product recommendation system 1000 searches for the most overlapping part using the distance between respective intention vectors and derives the position with the highest density as the first average intention vector Uₛ₁.

Hereinafter, a recommendation product derivation method according to an embodiment of the present invention will be described with reference to FIG. 11.

FIG. 11 is a flowchart illustrating an embodiment of a recommendation product derivation method.

The recommendation product derivation method described with reference to FIG. 11 includes the detailed method for performing the sampling intention vector derivation step S300 and the recommendation product derivation step 400 described above with reference to FIGS. 7 to 9.

Referring to FIG. 11, the recommendation product derivation method according to an embodiment of the present invention preferably includes a sampling intention vector derivation step S3100, an associated product vector derivation step S3200, an associated product vector filtering step S3300, a recommendation product vector index conversion step S3400, and a recommendation product conversion list generation step S3500.

In the sampling intention vector derivation step S3100, the example product and text input-based product recommendation system 1000 derives the sampling intention vector regarding the user's current intention from the probability distribution representing the user's current intention based on each of the first average intention vector Uₛ₁ and the second average intention vector Uₛ₂.

As described above, the probability distribution representing the user's current intention may be generated by collecting and analyzing the user's input data and its corresponding intention (label).

In the sampling intention vector derivation step S3100, the example product and text input-based product recommendation system 1000 may express the sampling intention vector for each of the first average intention vector Uₛ₁ and the second average intention vector Us₂ using Equation 6 described above.

Thus, in the sampling intention vector derivation step S3100, the example product and text input-based product recommendation system 1000 may analyze and extract intention for example products and/or need texts entered by the user.

In the associated product vector derivation step S3200, the example product and text input-based product recommendation system 1000 converts the sampling intention vector into the associated product vector using Equation 7 described above.

Thus, in the associated product vector derivation step S3200, the example product and text input-based product recommendation system 1000 performs conversion into product information corresponding to the user's intention information.

In the associated product vector filtering step S3300, the example product and text input-based product recommendation system 1000 performs filtering on the associated product vector derived from the first average intention vector and the associated product vector derived from the second average intention vector to derive the recommendation product vector.

In the recommendation product vector filtering step S3300, the example product and text input-based product recommendation system 1000 may infer overall preference information based on the user's past history, and perform sampling of the associated product based on the inferred user preference information. At this time, the user's past history data may include the user's past product purchase history, product inquiry history, and search history.

Therefore, in the recommendation product vector filtering step S3300, the example product and text input-based product recommendation system 1000 performs filtering on an associated product vector derived from the first average intention vector and an associated product vector derived from the second average intention vector based on the user's preference information to derive a recommendation product vector suitable for the user's preference.

In the recommendation product vector index conversion step S3400, the example product and text input-based product recommendation system 1000 converts the filtered associated product vector (recommendation product vector) into a product index.

Further, in the recommendation product conversion list generation step S3500, the example product and text input-based product recommendation system 1000 may convert the product index into a product name and provide recommendation product information and list to the user. The example product and text input-based product recommendation system 1000 may also provide one or more recommendation product names or provide the information and list of products searched for by the recommendation product names to the user terminal.

In addition, herein, the term “product” refers not only to tangible objects with value, but also intangible goods such as music files and videos.

Meanwhile, the above-described embodiments of the present invention can be implemented in the form of program commands that can be executed through various computer components and recorded on a computer-readable recording medium. The computer-readable recording medium may include program commands, data files, data structures, etc., alone or in combination. The program commands recorded on the computer-readable recording medium may be specially designed and configured for the present invention or may be known and available to those skilled in a computer software field. Examples of the computer-readable recording medium include magnetic media such as hard disks, floppy disks, and magnetic tape, optical storage media such as CD-ROMs and DVDs, magneto-optical media such as floptical disks, and hardware devices specifically configured to store and execute program instructions, such as ROM, RAM, and flash memory. Examples of the program instructions include not only machine language code produced by a compiler, but also high-level language code that can be executed by a computer using an interpreter, etc. The hardware device may be modified into one or more software modules to perform processing according to the present invention, and vice versa.

Methods and systems for product recommendation based on example products and text input according to embodiments of the invention can provide a recommendation product by inferring a user's current intention.

Further, Methods and systems for product recommendation based on example products and text input according to embodiments of the invention can perform product recommendation applicable to various product categories.

Specific implementations described in the present invention are merely exemplary and do not limit the scope of the present invention in any way. For the sake of brevity in the specification, descriptions of conventional electronic components, control systems, software, and other functional aspects of the systems may be omitted. Further, connections or connection members of lines between components shown in the drawings are merely illustrative of functional and/or physical or circuit connections. In an actual device, they may be replaced or represented by various additional functional, physical, or circuit connections. Unless explicitly stated otherwise, such as with “essential” or “important,” a component may not be necessarily required for the application of the present invention.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method for product recommendation based on example products and text input configured to be performed with a computing system, the computing system comprising a memory and a processor configured to identify a current intention of a user and provide recommendation product information, the method comprising the steps of:
inputting a text about at least one example product and current needs of the user;
deriving an intention vector of the user based on the at least one example product;
deriving intention information about the text using a Large Language Model (LLM);
deriving an average intention vector based on the intention vector and the intention information;
deriving one or more sampling intention vectors based on a probability distribution expressing the current intention of the user and the average intention vector, and
deriving a product corresponding to the sampling intention vector, the product corresponding to the sampling intention vector comprising a tangible product with value and an intangible product.

2. The method of claim 1, wherein the step of deriving the intention vector comprises the steps of:
expressing the at least one example product as an index;
sampling k feature vectors from a probability distribution regarding features of the at least one example product; and
encoding the feature vector into the intention vector,
wherein the k is an integer greater than or equal to 1.

3. The method of claim 2, wherein the step of deriving the average intention vector further comprises the steps of:
deriving a density of the intention vector using MPMD (Max Probability position of Mixed Distributions); and
deriving the average intention vector based on the density of the intention vector.

4. The method of claim 3, wherein the step of deriving the product corresponding to the sampling intention vector comprises the steps of:
deriving an associated product vector corresponding to the sampling intention vector;
filtering the associated product vector to derive a recommendation product vector;
converting the recommendation product vector into a recommendation product index; and
displaying the product corresponding to the sampling intention vector as a product corresponding to the recommendation product index.

5. The method of claim 4, wherein the step of deriving the product corresponding to the sampling intention vector further comprises the steps of:
generating user preference information based on a past product purchase history of the user, product inquiry history of the user, and search history of the user; and
deriving the recommendation product vector by performing filtering on the associated product vector based on the user preference information.

6. A method for product recommendation based on example products and text input configured to be performed with a computing system, the computing system comprising a memory and a processor configured to identify current intention of a user and provide recommendation product information, the method comprising the steps of:
inputting at least one example product;
deriving an intention vector of the user based on the at least one example product;
deriving an average intention vector based on the intention vector;
deriving one or more sampling intention vectors based on a probability distribution expressing the current intention of the user and the average intention vector, and
deriving a product corresponding to the sampling intention vector,
wherein the product corresponding to the sampling intention vector comprises a tangible product with value and an intangible product.

7. The method of claim 6, wherein the step of deriving the intention vector comprises the steps of:
expressing the at least one example product as an index;
sampling k feature vectors from a probability distribution regarding features of the at least one example product; and
encoding the feature vector into the intention vector,
wherein the k is an integer greater than or equal to 1.

8. The method of claim 7, wherein the step of deriving the average intention vector further comprises the steps of:
deriving a density of the intention vector using MPMD (Max Probability position of Mixed Distributions); and
deriving the average intention vector based on the density of the intention vector.

9. The method of claim 8, wherein the step of deriving the product corresponding to the sampling intention vector comprises the steps of:
deriving an associated product vector corresponding to the sampling intention vector;
filtering the associated product vector to derive a recommendation product vector;
converting the recommendation product vector into a recommendation product index; and
displaying the product corresponding to the sampling intention vector as a product corresponding to the recommendation product index.

10. The method of claim 9, wherein the step of deriving the product corresponding to the sampling intention vector further comprises the steps of:
generating user preference information based on a past product purchase history of the user, product inquiry history of the user, and search history of the user; and
deriving the recommendation product vector by performing filtering on the associated product vector based on the user preference information.

11. A method for product recommendation based on example products and text input configured to be performed with a computing system, the computing system comprising a memory and a processor configured to identify a current intention of the user and provide recommendation product information, the method comprising the steps of:
inputting a text about current needs of the user;
deriving intention information about the text using a Large Language Model (LLM);
deriving an average intention vector based on the intention information;
deriving one or more sampling intention vectors based on a probability distribution expressing a current intention of the user and the average intention vector, and
deriving a product corresponding to the sampling intention vector,
wherein the product corresponding to the sampling intention vector comprises a tangible product with value and an intangible product.

12. The method of claim 11, wherein the step of deriving the product corresponding to the sampling intention vector comprises the steps of:
deriving an associated product vector corresponding to the sampling intention vector;
filtering the associated product vector to derive a recommendation product vector;
converting the recommendation product vector into a recommendation product index; and
displaying the product corresponding to the sampling intention vector as a product corresponding to the recommendation product index.

13. The method of claim 12, wherein the step of deriving the product corresponding to the sampling intention vector further comprises the steps of:
generating user preference information based on a past product purchase history of the user, product inquiry history of the user, and search history of the user; and
deriving the recommendation product vector by performing filtering on the associated product vector based on the user preference information.

14. A system for product recommendation based on example products and text input, the system comprising:
at least one memory; and
at least one processor reading out at least one application stored in the memory to identify a current intention of a user and provide recommendation product information,
wherein the at least one memory, when executed by the at least one processor, is configured to cause the at least one processor to:
acquire a text about at least one product and current needs of the user;
derive an intention vector of the user based on the at least one example product;
derive intention information about the text using a Large Language Model (LLM);
derive an average intention vector based on the intention vector and the intention information;
derive one or more sampling intention vectors based on a probability distribution expressing the current intention of the user and the average intention vector, and
derive a product corresponding to the sampling intention vector,
wherein the product corresponding to the sampling intention vector comprises a tangible product with value and an intangible product.

15. A computing device, the device comprising:
at least one memory; and
at least one processor reading out at least one application stored in the memory to identify a current intention of a user and provide recommendation product information,
wherein commands of the processor comprise the steps of:
inputting a text about at least one example product and current needs of the user;
deriving an intention vector of the user based on the at least one example product;
deriving intention information about the text using a Large Language Model (LLM);
deriving an average intention vector based on the intention vector and the intention information;
deriving one or more sampling intention vectors based on a probability distribution expressing the current intention of the user and the average intention vector, and
deriving a product corresponding to the sampling intention vector,
wherein the product corresponding to the sampling intention vector comprises a tangible product with value and an intangible product.
